(19) United States
(12) Patent Application Publication
(10) Pub. No.: US 2022/0268876 A1
(43) Pub. Date: Aug. 25, 2022

(54) SPATIAL POSITION CALCULATION DEVICE

(71) Applicant: Toru ISHII, Osaka (JP)

(72) Inventor: Toru ISHII, Osaka (JP)

(21) Appl. No.: 17/638,173

(22) PCT Filed: Aug. 20, 2020
(86) PCT No.: PCT/JP2020/031537

§ 371 Date: Feb. 24, 2022

(30) Foreign Application Priority Data
Aug. 29, 2019 (JP) 2019-157121

(51) Int. Cl. G01S 5/30

(52) U.S. Cl. CPC G01S 5/30

(57) ABSTRACT

Provided is a spatial position calculation device that calculates a position of a measurement target in a space with high accuracy even when the measurement target moves at a high speed. Included are a transmission unit 1, 2 or 3 that transmits at a predetermined time interval a modulated sound signal obtained by modulating an original sound signal, a reception unit 4 that receives the modulated sound signal, a calculation unit 5 that calculates spatial position coordinates of either the transmission unit or the reception unit, or a distance from the transmission unit to the reception unit based on an arrival timing of the modulated sound signal to the reception unit, the arrival timing being obtained from cross-correlation calculation between a reference signal generated from the modulated sound signal and a reception signal of the reception unit, and a magnification change unit 47 that changes a magnification in a time direction of the reference signal or the reception signal.

### TECHNICAL FIELD

The present invention is a spatial position calculation device using a wave such as a sound wave or an ultrasonic wave.

### BACKGROUND ART

Patent Literature 1 discloses a technique for measuring a timing at which a wave such as a sound wave or an ultrasonic wave transmitted from a transmission unit reaches a reception unit, and calculating a position of the reception unit with respect to the transmission unit or a position of the transmission unit with respect to the reception unit. In addition, as a technology in which a transmission unit and a reception unit are disposed in a spatial vicinity, and a reciprocating time until a wave motion transmitted from the transmission unit is reflected by an object and returns to the reception unit is measured to calculate a position of the object, a radar technology using a radio wave for the wave motion and a sonar technology using a sound wave or an ultrasonic wave are widely known.

### CITATIONS LIST

### Patent Literature

Patent Literature 1: JP 2005-300504 A
Patent Literature 2: WO 2011/102130 A

### Non-Patent Literature

Non Patent Literature 1: Widodo, Slamet, et al. “Moving object localization using sound-based positioning system with doppler shift compensation.” Robotics 2.2 (2013): 36-53.
Non Patent Literature 2: Alvarez, Fernando J., et al. “Doppler-tolerant receiver for an ultrasonic LPS based on Kasami sequences.” Sensors and Actuators A: Physical 189 (2013): 238-253.

### SUMMARY OF INVENTION

### Technical Problems

As disclosed in Patent Literature 1, a technique using a phase or a frequency modulated signal of an ultrasonic wave has been conventionally reported regarding highly accurate position measurement that is difficult to realize with radio waves.

However, since an ultrasonic wave has a propagation velocity lower than that of a radio wave, in a case where any one of the transmission unit and the reception unit or a detection target that reflects a transmission wave is moving, a frequency shift generated in a reception signal due to the Doppler effect appears more significantly than that of the radio wave, and thus there is a problem that signal detection cannot be performed even at a velocity at which a person walks.

To address this issue, Patent Literature 2 discloses a technique of performing phase difference processing on an I component and a Q component of a reception signal based on a code period to remove a phase fluctuation due to the Doppler effect.

Non Patent Literature 1 further discloses a technique of correcting an error by calculating the frequency shift by performing fast Fourier transform (FFT) on a reception signal.

Non Patent Literature 2 further discloses a technique that includes a plurality of frequency filters, and measures an arrival timing of a reception signal in a reception unit by detecting a signal having the frequency shift by any of the plurality of filters.

However, in Patent Literature 2, the reception signal is divided into two components of the I component and the Q component, and difference calculation between the same components and between different components is performed, and in Non Patent Literature 1, frequency analysis by FFT is performed, and thus, there is a problem that an amount of the calculation is large, and processing time and power consumption are increased. Non Patent Literature 2 has a further problem that since the plurality of filters are provided, a circuit scale increases, and in addition, the frequency shift cannot be detected when exceeding upper and lower limits of the plurality of filters provided in advance.

An object of the present invention is to solve the above-described problems of the prior art, and to calculate a spatial position of a measurement target with high accuracy even when the measurement target moves at a high speed.

### Solutions to Problems

In order to achieve the above object, a spatial position calculation device of the present invention includes: a transmission unit that transmits at a predetermined time interval a modulated sound signal obtained by modulating an original sound signal; a reception unit that receives the modulated sound signal; a calculation unit that calculates spatial position coordinates of either the transmission unit or the reception unit, or a distance from the transmission unit to the reception unit based on an arrival timing of the modulated sound signal to the reception unit, the arrival timing being obtained from cross-correlation calculation between a reference signal generated from the modulated sound signal and a reception signal of the reception unit; and a magnification change unit that changes a magnification in a time direction of the reference signal or the reception signal.

According to the spatial position calculation device of the present invention, when the reception unit performs the cross-correlation calculation for specifying the arrival timing of the modulated sound signal from the transmission unit to the reception unit, a relative velocity between the transmission unit and the reception unit is predicted on the basis of a motion state that can occur between the transmission unit and the reception unit, and the magnification in the time direction of the reference signal or the reception signal is changed so as to compensate, by the Doppler effect due to the predicted relative velocity, expansion and contraction in the time direction caused in the reception signal, thereby eliminating the influence of the Doppler effect in the reception signal. As a result, even when the measurement target moves at a high speed, the position in the space of the measurement target can be calculated with high accuracy.

### Advantageous Effects of Invention

According to the spatial position calculation device of the present invention, it is possible to calculate the position of the measurement target in the space with high accuracy even when the measurement target moves at a high speed.

### BRIEF DESCRIPTION OF DRAWINGS

FIG. 1 is a system functional block diagram of an embodiment according to the present invention.

FIG. 2 is a timing chart illustrating a time relationship among modulated sound signals Y1, Y2, and Y3 and a reception signal X4.

FIG. 3 is a diagram illustrating a first example of an internal configuration of a transmission unit 1.

FIG. 4 is a timing chart of internal signals of FIG. 3.

FIG. 5 is a diagram illustrating an internal configuration example of a reception unit 4.

FIG. 6 is an explanatory diagram of cross-correlation calculation performed by a correlation calculation unit 45.

FIG. 7 is a graph illustrating a result of cross-correlation calculation with a horizontal axis representing a shift amount and a vertical axis representing a correlation value.

FIG. 8 is an explanatory diagram of cross-correlation calculation performed by the correlation calculation unit 45 similar to FIG. 6.

FIG. 9 is a graph illustrating a result of the cross-correlation calculation of FIG. 8 similarly to FIG. 7.

FIG. 10 is a diagram comparing a waveform of a modulated sound signal Yk emitted from a transmission unit k (where k=1, 2, 3) with a signal waveform when Yk is received by a reception unit 4.

FIG. 11 is an explanatory diagram of cross-correlation calculation performed by the correlation calculation unit 45 in a case where only Z2, which is a modulated sound signal from the transmission unit 2, contracts in a time direction due to the Doppler effect, as in FIG. 8.

FIG. 12 is a diagram illustrating a cross-correlation calculation result in FIG. 11.

FIG. 13 is an explanatory diagram of cross-correlation calculation performed by the correlation calculation unit 45 based on a second method different from those in FIGS. 6, 8, and 11.

FIG. 14 is a diagram illustrating a cross-correlation calculation result in FIG. 13.

FIG. 15 is an explanatory diagram of cross-correlation calculation performed by the correlation calculation unit 45 based on a third method different from those in FIGS. 6, 8, and 11.

FIG. 16 is a diagram illustrating a cross-correlation calculation result in FIG. 15.

FIG. 17 is a diagram illustrating a second example of the internal configuration of the transmission unit 1.

FIG. 18 is a timing chart of internal signals of FIG. 17.

### DESCRIPTION OF EMBODIMENT

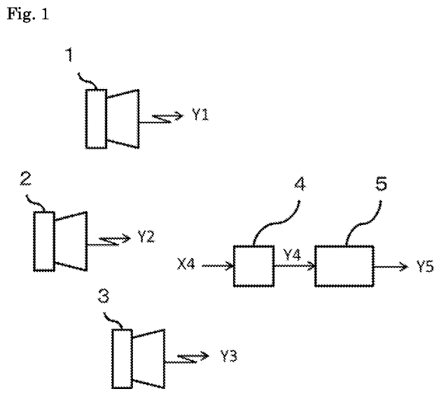

A system functional block diagram of an embodiment according to the present invention is illustrated in FIG. 1.

An entire system includes transmission units 1, 2, and 3 that are installed at different positions in a space and transmit binary phase modulated sound signals Y1, Y2, and Y3 by spread spectrum codes using different pseudo random numbers to the space at predetermined time intervals, a reception unit 4 that receives a reception signal X4 that is a signal on which the modulated sound signals Y1, Y2, and Y3 propagated through the space are superimposed, and outputs an arrival timing Y4 to the reception unit of each of the modulated sound signals Y1, Y2, and Y3, and a position calculation unit 5 that calculates spatial position coordinates Y5 of the reception unit 4 based on the arrival timing Y4. Note that the position calculation unit 5 is not necessarily separated from the reception unit 4, and may be included in the same housing as the reception unit 4.

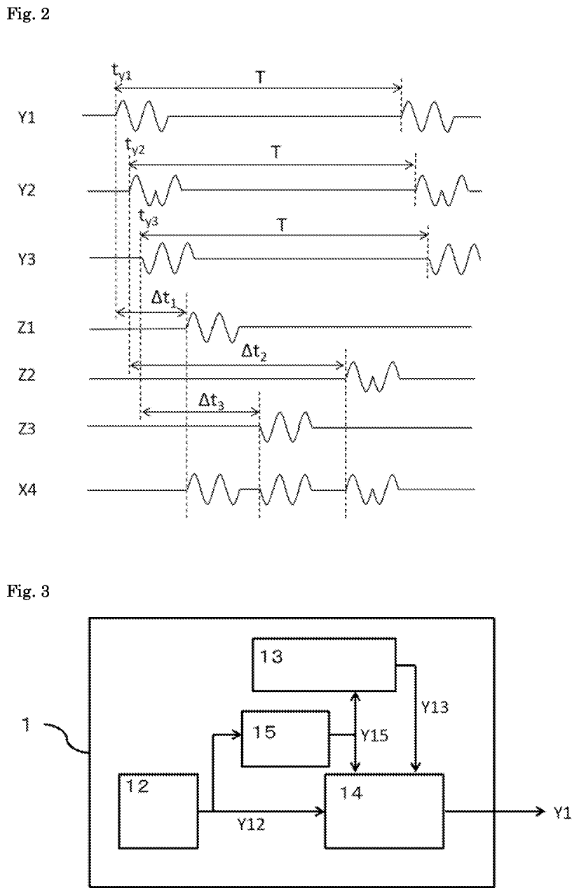

FIG. 2 is a timing chart illustrating a time relationship among the signals Y1, Y2, Y3, and X4. The modulated sound signals Y1, Y2, and Y3 are signals that have undergone binary phase modulation using code sequences different from each other. The modulated sound signals Y1, Y2, and Y3 are transmitted from the transmission units 1, 2, and 3 at the time t_{y1}, t_{y2}, and t_{y3}, respectively, and then reach the reception unit 4 as signals Z1, Z2, and Z3 delayed by propagation times Δt₁, Δt₂, and Δt₃ proportional to respective distances from each of the transmission units 1, 2, and 3 to the reception unit 4. The reception unit 4 receives the reception signal X4 on which the signals Z1, Z2, and Z3 have been superimposed.

When a predetermined time interval T elapses from the time point at which Y1, Y2, and Y3 are previously transmitted from the transmission units 1, 2, and 3, Y1, Y2, and Y3 are simultaneously transmitted again, and thereafter, the same processing is repeated.

Note that the predetermined time interval T may be selected in any manner as long as the position calculation unit 5 can know the output timing of the modulated sound signals from the transmission units 1, 2, and 3. In addition to a fixed value, for example, a method of sequentially changing the interval on the basis of a predetermined rule or a method of superimposing the value of the transmission interval T on the modulated sound signals every time and transmitting the superimposed signals to the position calculation unit 5 can be adopted.

For the transmission start times t_{y1}, t_{y2}, and t_{y3} from the respective transmission units, any selection method may be adopted as long as the time differences t_{y1}−t_{y2}, t_{y}−t_{y3}, and t_{y2}−t_{y1} between the respective transmission units can be known by the positioning calculation unit 5. For example, a method can be adopted in which the transmission start times are the same, that is, t_{y1}=t_{y2}=t_{y3}, or time differences t_{y1}−t_{y2}, t_{y2}−t_{y3}, and t_{y3}−t_{y1} are set to predetermined fixed values different from each other, or values of t_{y1}, t_{y2}, and t_{y3} are superimposed on the respective modulated sound signals Y1, Y2, and Y3 each time, and the superimposed signals are transmitted to the position calculation unit 5.

Therefore, in a case where any of Z1, Z2, and Z3 cannot be sufficiently received due to interference with another transmission signal, it is possible to improve a reception state by appropriately changing T, t_{y1}, t_{y2}, and t_{y3}.

In FIG. 2, for convenience of explanation, a short code having a code length 2 in which one wavelength of a carrier wave is applied to one code is described as an example of Y1, Y2, and Y3. However, in practical use, by using a spread spectrum code of a pseudo random number sequence having a longer code length as appropriate, it is possible to improve accuracy of calculation of the arrival timing of a reception signal to the reception unit 4, and interference resistance to noise and other signals.

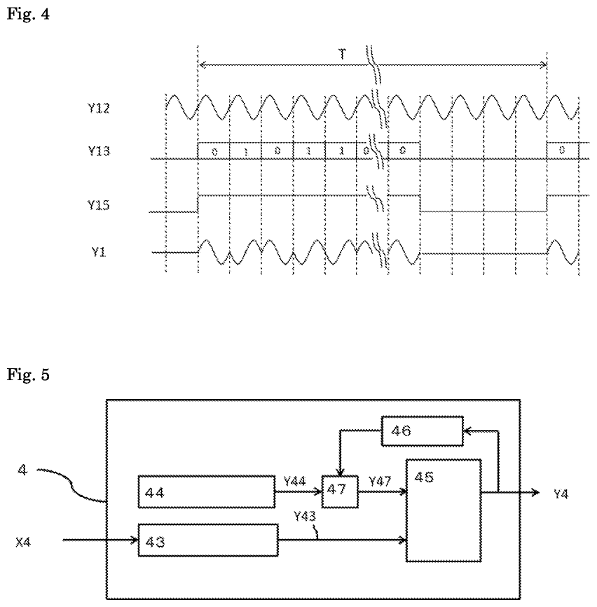

Next, a first example of an internal configuration of the transmission unit 1 is illustrated in FIG. 3, and a timing chart of internal signals of FIG. 3 is illustrated in FIG. 4. The transmission unit 1 includes an original sound signal generation unit 12, a pseudo random number generation unit 13, a modulation unit 14, and a control timer 15.

The original sound signal generation unit 12 includes, for example, a crystal oscillator, a built-in oscillator of a microcontroller, or the like, and generates an original sound signal Y12 having a constant frequency.

The control timer 15 outputs an operation control signal Y15 whose cycle is the T to the pseudo random number generation unit 13 and the modulation unit 14.

The pseudo random number generation unit 13 generates a binary pseudo random number Y13 of “1” or “0” according to a generally known pseudo random number sequence such as an M sequence, a Gold code, or a Kasami code.

The modulation unit 14 receives the original sound signal Y12 and the pseudo random number Y13, and sends out, to the air, the modulated sound signal Y1 to which binary phase modulation has been applied such that the phase is the same as that of the original sound signal Y12 when the value of Y13 is “0”, and the phase is opposite to that of the original sound signal Y12 when the value of Y13 is “1”.

Both the pseudo random number generation unit 13 and the modulation unit 14 are controlled by the control signal Y15 so as to operate during a Hi period of Y15 and stop during its Lo period. The pseudo random number generation unit 13 is reset at timing when Y15 changes from Lo to Hi next time, and outputs the predetermined pseudo random number Y13 from the head again.

In FIG. 4, an interval between rising edges at which Y15 transitions from Lo to Hi corresponds to the above-described T.

Also in the transmission unit 2 and the transmission unit 3, the internal configuration is similar to that in the transmission unit 1 illustrated in FIG. 3, and the timing of the internal signals is similar to that in the transmission unit 1 illustrated in FIG. 4, but the pseudo random number generated in each of the transmission unit 2 and the transmission unit 3 is different from Y13.

Assuming that the pseudo random numbers in the transmission unit 2 and the transmission unit 3 are the pseudo random number Y23 and the pseudo random number Y33, respectively, a pseudo random number that does not show a clear peak even in the cross-correlation calculation performed by use of any combination of the pseudo random numbers Y13, Y23, and Y33, that is, a pseudo random number having high orthogonality is selected, so that it is possible to extract the modulated sound signal of each transmission unit without mistaking the other by the cross-correlation calculation in the reception unit 4 to be described later.

Next, an internal configuration example of the reception unit 4 is illustrated in FIG. 5.

The reception unit 4 includes a reception buffer 43, a reference signal generation unit 44, a correlation calculation unit 45, a relative velocity prediction unit 46, and a magnification change unit 47.

The reception buffer 43 outputs a signal preserving the waveform of the reception signal X4 to the correlation calculation unit 45 as a reception recording signal Y43.

The reference signal generation unit 44 has a function similar to that of the modulation unit 14 in FIG. 3, and sequentially outputs the same signals as the modulated sound signals Y1, Y2, and Y3 of the transmission units 1, 2, and 3 to the magnification change unit 47 as a reference signal Y44.

The relative velocity prediction unit 46 predicts a relative velocity between each of the transmission units 1, 2, and 3 and the reception unit 4, and sets, in the magnification change unit 47, a magnification for compensating, by the Doppler effect due to the predicted relative velocity, expansion and contraction in the time direction caused in the reception signal.

The magnification change unit 47 expands and contracts the reference signal Y44 in the time direction according to the above-described magnification designated by the relative velocity prediction unit, and outputs the reference signal to the correlation calculation unit 45 as a correction reference signal Y47.

The correlation calculation unit 45 calculates the timing at which the reception unit 4 receives the modulated sound signal from each transmission unit by performing cross-correlation calculation of the reception recording signal Y43 and the correction reference signal Y47.

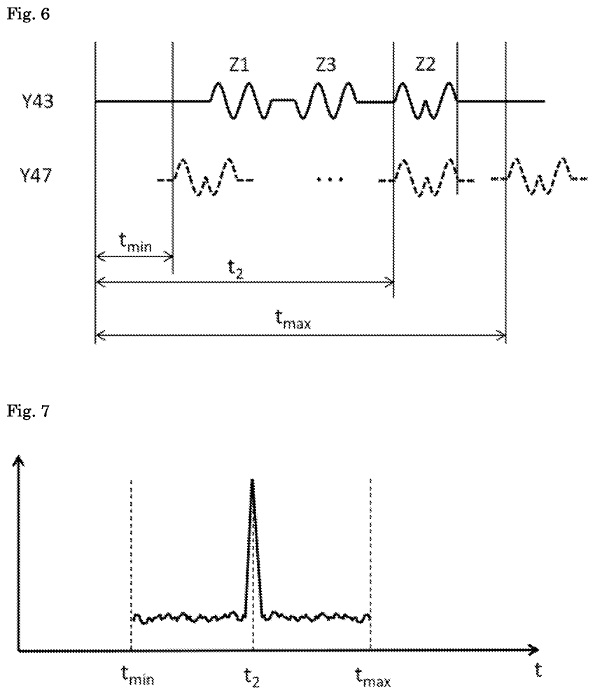

FIG. 6 is an explanatory diagram of cross-correlation calculation performed by the correlation calculation unit 45. Here, an example of calculating the arrival timing of Z2, which is the modulated sound signal from the transmission unit 2 in FIG. 2, to the reception unit 4 is illustrated.

The reception recording signal Y43 obtained by copying a section necessary for the correlation calculation from the reception signal X4, and the correction reference signal Y47 obtained by performing the above-described magnification change on Y44 that is a replica of the modulated sound signal Y2 of the transmission unit 2 are input to correlation calculation unit 45. FIG. 6 illustrates an example in which the relative velocity between the transmission unit 2 and the reception unit 4 is 0, and the above-described predicted relative velocity is also 0. Therefore, Y47 has the same waveform as the reference signal Y44 as a result.

Note that the interval required for the correlation calculation can be determined as an interval from tₘᵢₙ to tₘₐₓ when the propagation time at the shortest distance is represented as tₘᵢₙ and the propagation time at the longest distance is represented as tₘₐₓ, which can be taken due to the positional relationship between the reception unit 4 and the transmission unit 2.

The correlation calculation unit 45 performs cross-correlation calculation on the reception recording signal Y43 by sequentially shifting the correction reference signal Y47 from tₘᵢₙ to tₘₐₓ, obtains a timing t₂ at which the correlation indicates the maximum peak, and calculates this time point as a timing at which Z2 is received by the reception unit 4.

FIG. 7 is a graph showing a result of the cross-correlation calculation as a shift amount on a horizontal axis and a correlation value on a vertical axis.

Furthermore, the reception unit 4 performs processing similar to the processing for obtaining t₂ of the transmission unit 2 in FIGS. 6 and 7 also for the transmission unit 1 and the transmission unit 3, thereby similarly calculating t₁ and t₃ that are timings at which Z1 and Z3 are received by the reception unit 4, respectively.

t₁, t₂, and t₃ obtained by the reception unit 4 as described above are collectively output to the position calculation unit 5 as the arrival timing Y4 to the reception unit 4, and the spatial position coordinates Y5 of the reception unit 4 is calculated in the position calculation unit 5.

There are a plurality of methods for calculating the spatial position coordinates of the reception unit 4 in the position calculation unit 5.

For example, when the reception unit 4 knows the transmission start times t_{y1}, t_{y2}, and t_{y3} of the modulated sound signals Y1, Y2, and Y3 in FIG. 2 in advance by some means, the reception unit 4 adjusts a time point corresponding to t₂=0 at a left end of FIG. 6 to t_{y1}, t_{y2}, and t_{y3} to obtain respective required times Δt₁, Δt₂, and Δt₃ from transmission of Y1, Y2, and Y3 to the reception unit 4 as Δt₁=t₁, Δt₂=t₂, and Δt₃=t₃. Therefore, by multiplying t₁, t₂, and t₃ by the sound velocity, the distances r₁, r₂, and r₃ between the transmission units 1, 2, and 3 and the reception unit 4 are obtained, and the position calculation unit 5 can calculate the position coordinates of the reception unit 4 based on the transmission units 1, 2, and 3 on the basis of the principle of trilateration.

Alternatively, even in a case where the reception unit 4 cannot know the transmission start times t_{y1}, t_{y2}, and t_{y3} of Y1, Y2, and Y3 in FIG. 2, if t_{y1}=t_{y2}=t_{y3}, differences Δt₃−Δt₁, Δt₁−Δt₂, and Δt₂−Δt₃ for three combinations of selecting two from the three of Δt₁, Δt₂, and Δt₃ in FIG. 2 are obtained from t₃−t₁, t₁−t₂, and t₂−t₃, respectively. Therefore, the position coordinates of the reception unit 4 can be calculated by the principle generally known as time difference of arrival (TDoA) that calculates the position from the time difference in which the signals simultaneously transmitted from different spatial positions reach a certain point.

In FIGS. 6 and 7, the case where the transmission unit and the reception unit are relatively stationary has been described. However, in a case where the reception unit moves with a relative velocity with respect to the transmission unit, it is difficult to calculate the position coordinates unless the above-described magnification change is performed by the magnification change unit 47 due to the influence of the Doppler effect appearing in the reception signal.

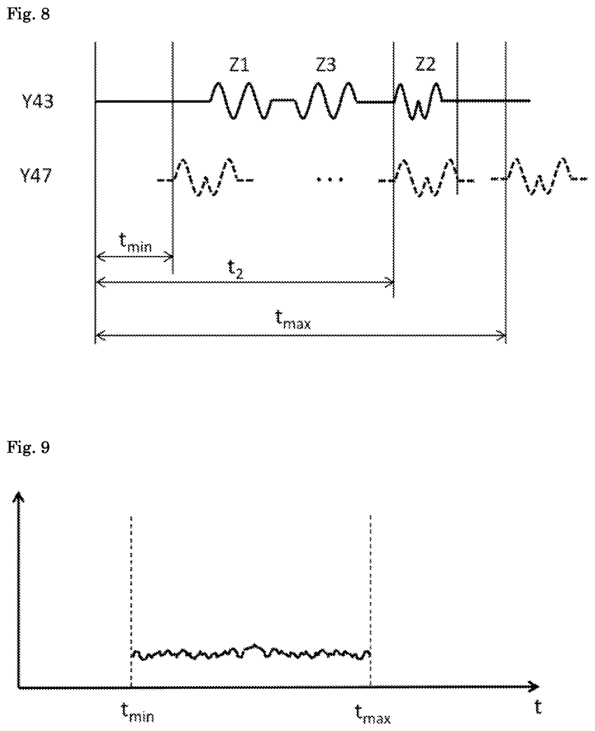

The reason for this will be described with reference to FIGS. 8 and 9.

FIG. 8 is an explanatory diagram of cross-correlation calculation performed by the correlation calculation unit 45 similar to FIG. 6, but Z2, which is the modulated sound signal from the transmission unit 2, contracts in the time direction due to the Doppler effect, which is a difference from FIG. 6.

In FIG. 8, even though the portion Z2 of the reception recording signal Y43 copied from the reception signal X4 contracts due to the Doppler effect, the reference signal Y44 is input as it is as the correction reference signal Y47. Thus, even if cross-correlation calculation is performed by sequentially shifting Y47 with respect to Y43, a degree of expansion and contraction of Z2 in the time direction due to the Doppler effect is large. Therefore, as illustrated in FIG. 9, a phenomenon occurs in which a peak point indicating a high correlation does not clearly appear in a result of the cross-correlation calculation.

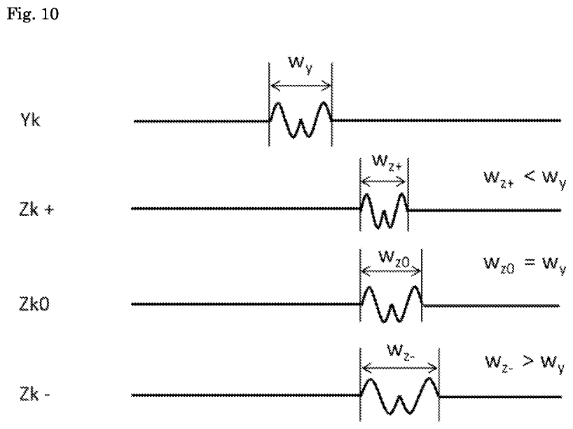

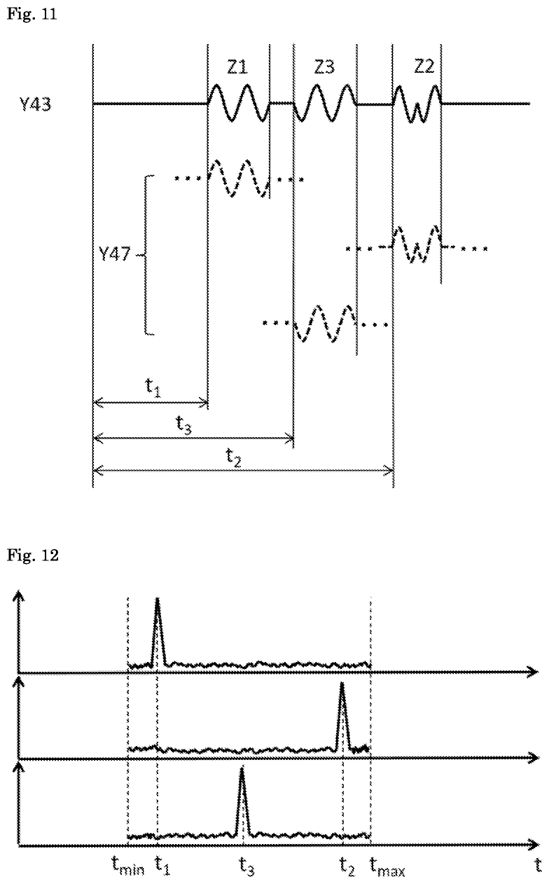

Next, the principle of the present invention for correcting the influence of the Doppler effect appearing in the reception signal, and obtaining the position coordinates of the reception unit will be described with reference to FIGS. 10 and 11.

FIG. 10 is a comparison between the waveform of the modulated sound signal Yk emitted from the transmission unit k (where k=1, 2, 3) and the received signal waveform of Yk at the reception unit 4, and Zk+, Zk0, and Zk− indicate the waveform in a case where the reception unit 4 approaches the transmission unit k, a case where the reception unit 4 is stationary, and a case where the reception unit 4 moves away from the transmission unit k, respectively.

w_{y} is the time width of the waveform of Yk, and the time width w_{z0} of Zk0 is equal to w_{y}, but due to the Doppler effect, the time width w_{z+} of Zk+ is shorter than w_{y}, and conversely, the time width w_{z-} of Zk− is longer than w_{y}.

Now, when the reception unit 4 is moving in a space at a relative velocity vₖ (where vₖ>0 is a direction approaching each other) with respect to the transmission unit k fixed at a predetermined position in the space, the time width w_{zk} of the signal waveform in which the above-described Yk is received by the reception unit 4 is expressed as

$${w}_{zk} = ( \frac{{v}_{s}}{{v}_{s} + {v}_{k}} ) \cdot {w}_{y} \qquad [ Mathematical formula 1 ]$$

based on the Doppler effect, where a sound velocity is vₛ.

Therefore, if the reception unit 4 knows the above-described relative velocity vₖ with respect to each of the transmission units k by some means, by setting a magnification rₖ, which is an expansion and contraction ratio of w_{zk} with respect to the above-described wy, in the magnification change unit 47 according to the following formula, even in a case where the relative velocity between the transmission unit k and the reception unit 4 is large, the influence of the Doppler effect having different degrees is compensated for every transmission unit k, so that a peak point indicating a high correlation in the cross-correlation calculation result can be always obtained.

$${r}_{k} = \frac{{w}_{zk}}{{w}_{y}} = ( \frac{{v}_{s}}{{v}_{s} + {v}_{k}} ) \qquad [ Mathematical formula 2 ]$$

FIG. 11 is an explanatory diagram of the cross-correlation calculation performed by the correlation calculation unit 45 in a case where only Z2, which is the modulated sound signal from the transmission unit 2, contracts in the time direction due to the Doppler effect, as in FIG. 8.

However, FIG. 11 is different from FIG. 8 in that the magnification rk obtained based on the relative velocity vₖ between the transmission unit k and the reception unit 4 predicted by the relative velocity prediction unit 46 is set in the magnification change unit 47, and the correction reference signal Y47 obtained by expanding and contracting the reference signal Y44 in accordance with expansion and contraction of Y43 by the Doppler effect is used.

FIG. 12 is a diagram illustrating a cross-correlation calculation result in FIG. 11.

The difference from FIG. 9 is that, by setting the magnification rk set in the magnification change unit 47 for each cross-correlation calculation with the reference signal Y44 of each of the transmission units k, even when the relative velocities of the reception unit 4 with respect to the transmission units k are different, a peak point indicating high correlation can be obtained in the cross-correlation calculation result with each of the transmission units, and as a result, the position calculation unit 5 in the subsequent stage can accurately calculate the position.

Note that the prediction of the relative velocity in the relative velocity prediction unit 46 includes, for example, a method of obtaining the relative velocity from a sensor device separately attached to the reception unit 4 that measures a motion state such as acceleration or angular velocity, a method of using a velocity to be compensated with a magnification finally set in the magnification change unit when the latest past arrival timing is calculated, a method of obtaining the relative velocity from a ratio between the predetermined time interval T in the transmission unit and a time interval T′ obtained from a difference between the latest past two arrival timings in the reception unit, and the like.

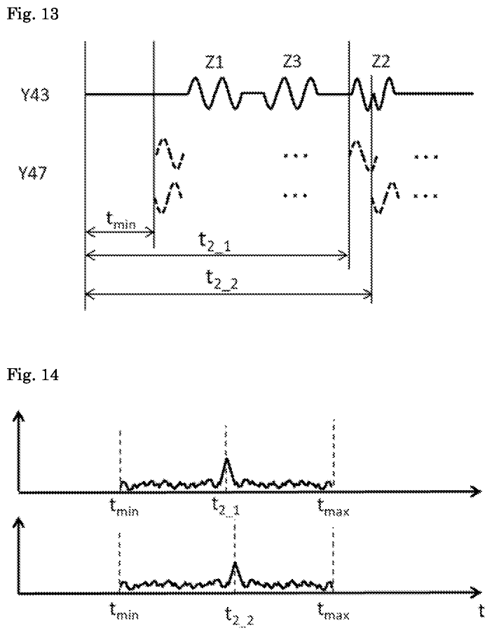

Alternatively, as a second method of the relative velocity prediction, as illustrated in FIGS. 13 and 14, signals obtained by partly cutting off the correction reference signal Y47 are extracted at two different parts, and correlation calculation between the reception signal and the signals at the two parts is performed by the correlation calculation unit 45. By comparing an interval t_{2_2}−t_{2_1} between the correlation peaks at the two parts with an interval t_{d12} between the two parts obtained by cutting off the correction reference signal having a given value, a magnification r₂ set in the magnification change unit 47 and a relative velocity v₂ can be obtained by the following formulas. Note that t_{2_1}, t_{2_2}, r₂, and v₂ are all values for the transmission unit 2 as an example.

$${r}_{2} = ( \frac{{t}_{2 \_ 2} - {t}_{2 \_ 1}}{{td}_{12}} ) \qquad [ Mathematical formula 3 ]$$

$${v}_{2} = {v}_{s} ( \frac{1}{{r}_{2}} - 1 ) \qquad [ Mathematical formula 4 ]$$

Alternatively, as a third method of the relative velocity prediction, the relative velocity can be obtained from intervals of a plurality of correlation peaks obtained by using extracted correction reference signals obtained by extracting three or more different parts cut off from the correction reference signal Y47 and performing correlation calculation between the extracted correction reference signals and the reception signal by the correlation calculation unit 45.

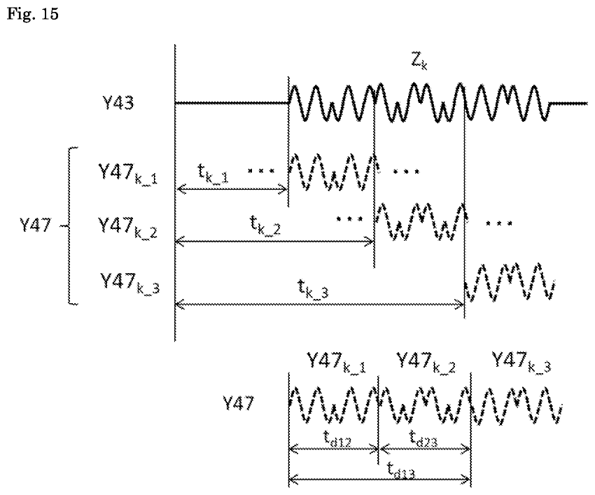

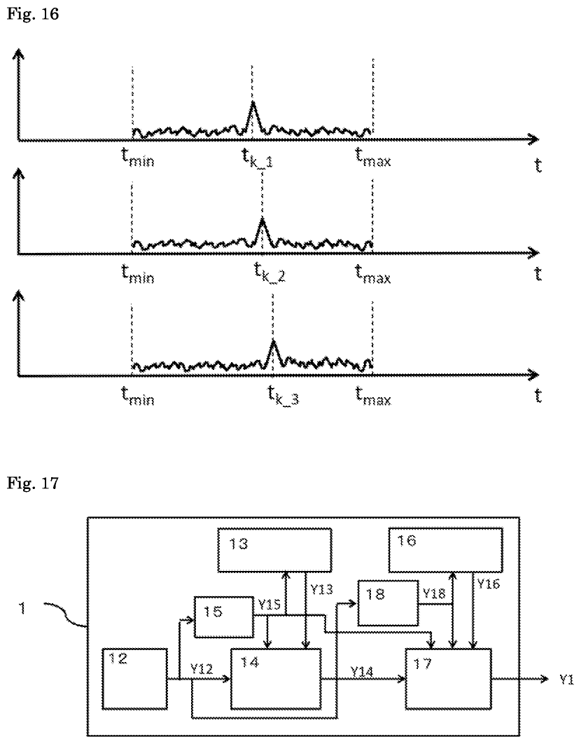

An example of this method is illustrated in FIGS. 15 and 16. t_{k_1}, t_{k_2}, and t_{k_3} in FIG. 15 are timings at which the maximum peak of the correlation with the reception signal Y43 is obtained for the extracted correction reference signals Y47_{k_1}, Y47_{k_2}, and Y47_{k_3} obtained by dividing the entire reference signal Y47 for the transmission unit k into three. The magnification rₖ set in the magnification change unit 47 and the relative velocity vₖ can be obtained based on the following formulas by comparing the intervals t_{k_2}−t_{k_1}, t_{k_3}−t_{k_2}, and t_{k_3}−t_{k_1} of the plurality of correlation peaks with the given mutual intervals t_{d12}, t_{d23}, and t_{d13} of the extracted correction reference signals Y47_{k_1}, Y47_{k_2}, and Y47_{k_3}.

$$[ Mathematical formula 5 ]$$

$${r}_{k} = \frac{1}{3} ( \frac{{t}_{k \_ 2} - {t}_{k \_ 1}}{{td}_{12}} + \frac{{t}_{k \_ 3} - {t}_{k \_ 2}}{{td}_{23}} + \frac{{t}_{k 3} - {t}_{k \_ 1}}{{td}_{13}} )$$

$${v}_{k} = {v}_{s} ( \frac{1}{{r}_{k}} - 1 ) \qquad [ Mathematical formula 6 ]$$

In the above (Mathematical formula 5), when obtaining the result, the calculated values obtained at the three correlation peak intervals, respectively, are averaged. In order to finally obtain one magnification rₖ and the Doppler velocity from a plurality of the obtained correlation peak intervals as described above, in addition to taking the average, it is possible to improve the calculation accuracy by appropriately selecting or combining a method such as using an intermediate value, selecting a value having the largest sum of each correlation peak, or selecting a value closest to another predicted value obtained from a time series change in the Doppler predicted velocities at the previous time and before.

In addition, as the extracted correction reference signal used in (Mathematical formula 3) to (Mathematical formula 6), a section having a short time width in which the influence of the Doppler effect is reduced to the extent that the peak can be detected within the assumed relative velocity range is cut out from the correction reference signal Y47, or the modulated sound signal and the reference signal are configured in advance by a series of signals consisting of plural different pseudo random number sequences having approximately the same length as the above-mentioned short time width, and the plural pseudo random number sequences are selected as the extracted correction reference signal, so that the correlation peak can be obtained for each section of the extracted correction reference signal although the peak value is lower than that in the case where the entire correction reference signal Y47 is used.

Furthermore, in order to compensate for the Doppler effect due to the relative velocity predicted by any one of the above methods, a method can be adopted in which each magnification set in the magnification change unit 47 for each of the transmission units is set as an initial value, then the magnification is scanned around the initial value, correlation calculation with each transmission unit is performed by the correlation calculation unit 45, and the Doppler velocity corresponding to the magnification at which the correlation value of the correlation calculation indicates the maximum value is consequently set as the relative velocity between the reception unit 4 and each transmission unit.

Note that the last method corresponds to accurately obtaining the relative velocity at that time rather than prediction. However, this method requires scanning in a wide range in a case where the previous latest magnification cannot be obtained as in the case of the first measurement, and there is a possibility that the calculation load increases and measurement in real time becomes difficult. Therefore, it is possible to calculate a more accurate relative velocity with the lapse of time while obtaining a result in real time by appropriately combining the two methods such that measurement is performed by the former method with a light calculation load when the previous latest magnification cannot be obtained, and the latter method is adopted narrowing the scan range after the previous latest magnification is obtained.

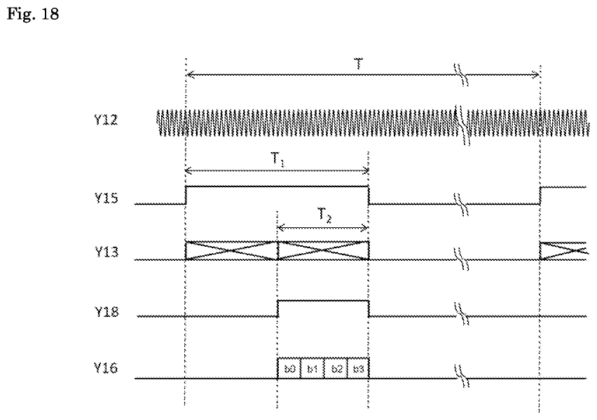

Next, a second example of the internal configuration of the transmission unit 1 is illustrated in FIG. 17, and a timing chart of internal signals of FIG. 17 is illustrated in FIG. 18.

The original sound signal generation unit 12, the pseudo random number generation unit 13, the modulation unit 14, and the control timer 15 in FIG. 17 are the same as those described above with reference to FIG. 3, but the transmission unit 1 here further includes a communication data generation unit 16, a secondary modulation unit 17, and a secondary modulation control timer 18.

The secondary modulation control timer 18 measures time in synchronization with the original sound signal Y12, and outputs an operation control signal Y18 having a constant cycle to the communication data generation unit 16 and the secondary modulation unit 17.

The communication data generation unit 16 generates data code string Y16 in which the communication data to be transmitted is expressed as a binary data string of either “1” or “0”.

The secondary modulation unit 17 outputs, as Y1, a signal obtained by performing binary phase modulation on primary modulated sound signal Y14 using the data code string Y16.

Here, the communication data to be transmitted as Y16 may be the next transmission interval data corresponding to T in FIG. 2 described above, data that can improve the measurement accuracy of the position, velocity, transmission time, ambient temperature, or the like of the transmission unit, or arbitrary data completely independent of the measurement, such as music or the like.

FIG. 18 is an explanatory diagram of the timing of the internal signals of FIG. 17.

The pseudo random number generation unit 13 and the modulation unit 14 are controlled by the control signal Y15 from the control timer 15, and both operate during a period when Y15 is Hi, and stop during a period of its Lo.

Length T₁ of the period during which Y15 is Hi is set to two cycles of the pseudo random number Y13 from the pseudo random number generation unit 13, and the pseudo random number Y13 is continuously output twice.

The communication data generation unit 16 is controlled by a control signal Y18 from the control timer 18, and both operate during a period when Y18 is Hi, and stop during a period of its Lo.

Under the control of Y15 and Y18, the secondary modulation unit 17 outputs Y14, which is an input, as it is to Y1 during a period in which Y15=Hi and Y18=Lo, and further performs binary phase modulation on Y14 using the data code string Y16 and outputs the modulated signal to Y1 such that the phase of the signal becomes the same as that of Y14 when the value of Y16 is “0” and the phase becomes opposite to that of Y14 when the value of Y16 is “1” during a period in which Y15=Hi and Y18=Hi.

Note that, in FIG. 18, an interval of the rising edge at which Y15 transitions from Lo to Hi corresponds to the above-described time interval T.

Now, in a case where T is not constant but variable, only the control timer 15 has to be designed so that the period of Y15=Lo is variable while the period of Y15=Hi is always kept constant, and both the pseudo random number generation unit 13 and the modulation unit 14 can cope with this case without any particular change from the case where T is constant.

Also in the transmission unit 2 and the transmission unit 3, the internal configuration is the same as that in FIG. 17 and the timing of the internal signals is the same as that in FIG. 18, but only the pseudo random numbers generated in the transmission unit 2 and the transmission unit 3 are different from Y13, which is similar to the case of the first example described with reference to FIGS. 3 and 4.

### REFERENCE SIGNS LIST

1 to 3 transmission unit
4 reception unit
5 position calculation unit
12 original sound signal generation unit
13 pseudo random number generation unit
14 modulation unit
15 control timer
16 communication data generation unit
17 secondary modulation unit
18 secondary modulation control timer
43 reception buffer
44 reference signal generation unit
45 correlation calculation unit
46 relative velocity prediction unit
47 magnification change unit

1. A spatial position calculation device comprising:
a transmission unit that transmits at a predetermined time interval a modulated sound signal obtained by modulating an original sound signal;
a reception unit that receives the modulated sound signal;
a calculation unit that calculates spatial position coordinates of either the transmission unit or the reception unit, or a distance from the transmission unit to the reception unit based on an arrival timing of the modulated sound signal to the reception unit, the arrival timing being obtained from cross-correlation calculation between a reference signal generated from the modulated sound signal and a reception signal of the reception unit;
a magnification change unit that changes a magnification in a time direction of the reference signal or the reception signal; and
a relative velocity prediction unit that predicts a relative velocity between the transmission unit and the reception unit based on a motion state that can occur between the transmission unit and the reception unit,
wherein a magnification for compensating expansion and contraction of the reception signal in the time direction caused by a Doppler effect at the relative velocity is set in the magnification change unit, and
wherein the relative velocity prediction unit predicts the relative velocity based on a mutual time interval between a plurality of correlation peaks obtained by cross-correlation calculation between the reception signal and a plurality of extracted correction reference signals obtained by extracting a plurality of different parts cut off from the reference signal.

2. (canceled)

3. (canceled)

4. The spatial position calculation device according to claim 1, wherein the relative velocity prediction unit sequentially sets, in the magnification change unit, a magnification of a predetermined range for compensating expansion and contraction of the reception signal in the time direction caused by the Doppler effect at a relative velocity from a lower limit to an upper limit of a range that the relative velocity can take, and finally sets, in the magnification change unit, a magnification at which the correlation value is maximized from among a plurality of times of the cross-correlation calculation.

5. The spatial position calculation device according to claim 1, wherein
a plurality of the transmission units are provided, and
an independent magnification for each of the plurality of transmission units is set in the magnification change unit to calculate spatial position coordinates of the reception unit.

6. The spatial position calculation device according to claim 1, wherein a modulated signal with a spread spectrum code is used as the modulated sound signal.

7. The spatial position calculation device according to claim 1, wherein the modulated sound signal includes a plurality of different spread spectrum codes in a row, and the plurality of different spread spectrum codes correspond to the plurality of extracted correction reference signals.
